(19) United States
(12) Patent Application Publication
(10) Pub. No.: US 2009/0169903 A1
(43) Pub. Date: Jul. 2, 2009

(54) PROCESS FOR PRODUCING METAL SUBSTRATE WITH MULTILAYER FILM, METAL SUBSTRATE WITH MULTILAYER FILM OBTAINED BY THE PROCESS, AND COATED ARTICLE

(75) Inventor: Kentaro KUBOTA, Hiratsuka-shi (JP)

Correspondence Address: KRATZ, QUINTOS & HANSON, LLP, 1420 K Street, N.W., Suite 400, WASHINGTON, DC, 20005, US

(73) Assignee: KANSAI PAINT CO., LTD., Amagasaki-shi (JP)

(21) Appl. No.: 12/331,046

(22) Filed: Dec. 9, 2008

(30) Foreign Application Priority Data
Dec. 27, 2007 (JP) 2007-337536

(51) Int. Cl. B32B 15/04; C25D 5/48

(52) U.S. Cl. 428/457; 205/198

(57) ABSTRACT

The present invention provides a process for producing a metal substrate with a multilayer film that has excellent corrosion resistance. Specifically, the process comprising immersing a metal substrate in an aqueous bismuth compound solution (A) and applying an electric current between the metal substrate and an electrode to thereby form a coating film (F1) on the metal substrate; and then applying a coating composition (B) on the coating film (F1) to form a coating film (F2).

### TECHNICAL FIELD

The present invention relates to a process for producing a metal substrate with a multilayer film, a metal substrate with a multilayer film obtained by the process, and a coated article. The present invention also relates to a process for forming a multilayer film.

### BACKGROUND ART

It has been heretofore known that the surfaces of industrial metal substrates are treated by cathodic electrolysis or with a metal phosphate, a metal oxide, and/or the like, as surface preparation to improve adhesion and corrosion resistance before application of a coating composition.

In order to further improve adhesion and corrosion resistance, a metal substrate after surface treatment with a metal phosphate, a metal oxide, and/or the like, is treated with a chromic acid-containing aqueous solution (hereinafter sometimes referred to as “post-treatment”). However, such a treatment involves many environmental problems.

To avoid these problems, the following treatments have been proposed.

Japanese Unexamined Patent Publication No. 1981-136979 discloses a post-treatment method after phosphating, characterized by performing a “post-treatment” with a treatment liquid containing a chelating agent as a main component, immediately after phosphating a cold rolled steel sheet, a galvanized steel sheet, or a shaped product thereof.

Japanese Unexamined Patent Publication No. 1986-199074 discloses a post-treatment method as a “post-treatment” after chemical conversion, characterized by spraying a chemical conversion liquid onto a substrate removed from a chemical conversion reactor after chemical conversion by immersion in the reactor.

Japanese Unexamined Patent Publication No. 2001-9365 discloses a method for coating a metallic material, characterized by performing a “post-treatment” on a metallic material that has been surface-treated with a phosphating liquid, with an aqueous solution containing a specific phenol compound derivative, followed by drying and powder coating. The treatment liquid disclosed in this publication is different from that used in the present invention.

Further, Japanese Unexamined Patent Publication No. 1994-299376 discloses that a film is formed by causing trivalent bismuth ions to be present in an acidic aqueous solution and thereby depositing bismuth on the surface of an iron group element; and that the film forms a composite film with an oxide layer of the iron group element. The publication states that such a method achieves an excellent corrosion-inhibiting effect.

Furthermore, Japanese Unexamined Patent Publication No. 2006-249451 discloses a surface-treating agent for zinc or zinc alloy products, characterized by containing at least one water-soluble compound containing antimony, bismuth, tellurium, or tin.

However, sufficient corrosion resistance, and in particular sufficient long-term corrosion resistance, such as weathering corrosion resistance and the like, cannot be achieved only by depositing bismuth on the surface to be coated and thereby forming a film, as in Japanese Unexamined Patent Publication Nos. 1994-299376 and 2006-249451. Moreover, in these publications, the films are formed without applying an electric current, and such films have insufficient corrosion resistance.

The methods of these publications therefore cannot achieve sufficient adhesion, corrosion resistance, and in particular long-term corrosion resistance, such as weathering corrosion resistance and the like.

### BRIEF DESCRIPTION OF DRAWINGS

FIG. 1 is a schematic diagram of an industrial line process including the step of treating with an “aqueous bismuth compound solution”.

1. Hot-water washing; 2. hot-water washing; 3. degreasing; 4. washing with industrial water; 5. washing with pure water; 6. surface preparation (omissible); 7. chemical conversion (omissible); 8. water washing (omissible); 9. treatment with an aqueous bismuth compound solution (according to the process of the present invention); 10. water washing; 11. setting or thermal drying.

### DISCLOSURE OF THE INVENTION

An object of the present invention is to find a process for forming a multilayer film with excellent corrosion resistance, and in particular weathering corrosion resistance, and to provide a coated article having a film with such excellent properties.

As a result of extensive research to achieve the above object, the present inventors found that the above-mentioned problems of the prior art can be solved by a process for producing a metal substrate with a multilayer film, the process comprising: immersing a metal substrate in an aqueous bismuth compound solution (A) and applying an electric current between the metal substrate and an electrode to thereby form a coating film (F1) on the metal substrate; and then applying a coating composition (B) on the coating film (F1) to form a coating film (F2). The present invention has been thus accomplished.

That is, the present invention provides the following process for producing a metal substrate with a multilayer film; metal substrate with a multilayer film obtained by the process; a coated article; and a process for forming a multilayer film.

1. A process for forming a multilayer film, comprising immersing a metal substrate in an aqueous bismuth compound solution (A) and applying an electric current between the metal substrate and an electrode to thereby form a coating film (F1) on the metal substrate; and then applying a coating composition (B) on the coating film (F1) to form a coating film (F2).

2. A metal substrate with a multilayer film, which is obtained by the process according to Item 1.

3. A process for producing a metal substrate with a multilayer film, comprising immersing a metal substrate in an aqueous bismuth compound solution (A) and applying an electric current between the metal substrate and an electrode to thereby form a coating film (F1) on the metal substrate; and then applying a coating composition (B) on the coating film (F1) to form a coating film (F2).

4. The process according to Item 3, wherein the aqueous bismuth compound solution (A) is an aqueous solution containing at least one bismuth compound selected from the group consisting of bismuth nitrate, bismuth lactate, and bismuth methoxyacetate.

5. The process according to Item 3, wherein the metal substrate is a metal substrate treated by zinc phosphate-based chemical conversion.

6. A metal substrate with a multilayer film, which is obtained by the process according to Item 3.

7. A coated article comprising the metal substrate according to Item 2 or Item 6.

The present invention is described below in further detail.

### Metal Substrate

Examples of the metal substrate used in the present invention include zinc, iron, aluminium, magnesium, steel, alloys thereof, galvanized sheet iron, etc. Such substrates may be those treated by cold rolling, hot rolling, molding, grinding, acid cleaning, etc. More specific examples include construction materials, electrical products, office machines, automobile bodies, parts, etc.

Such metal substrates may be surface-treated with a phosphating solution (chemical conversion). Specifically, for example, it is preferable to use an aqueous solution or dispersion containing one or more metal salts selected from the group consisting of iron phosphate, manganese phosphate, zinc phosphate, and zinc phosphate containing calcium ions, nickel ions, magnesium ions, cobalt ions, or the like. The concentration of such metal salts can be arbitrarily selected according to the purpose, but it is usually preferable that the concentration be within the range of 1 to 30 mass %.

When the metal substrate is surface-treated with a phosphating solution, a method known per se can be used without limitation. The surface treatment can be carried out by, for example, immersing the metal substrate in an aqueous phosphate solution or dispersion, or by spraying the metal substrate with an aqueous phosphate solution or dispersion. Of these methods, immersion in an aqueous phosphate dispersion is preferable from the viewpoint of corrosion resistance. The temperature of the aqueous phosphate solution or dispersion is not limited, but it is usually preferable that the temperature be within the range of 10 to 60° C.

### Aqueous Bismuth Compound Solution (A)

The aqueous bismuth compound solution (A) is obtained by adding, if necessary, an acid to a bismuth compound, and diluting with water to a solids content of 0.05 to 30 mass %, preferably 0.1 to 30 mass %, more preferably 0.1 to 10 mass %. In the solution, at least part of the bismuth compound is present as bismuth ions.

Examples of the bismuth compound include inorganic bismuth-containing compounds, such as bismuth chloride, bismuth oxychloride, bismuth bromide, bismuth silicate, bismuth hydroxide, bismuth trioxide, bismuth nitrate, bismuth nitrite, bismuth oxycarbonate, etc.; and organic-based bismuth compounds such as bismuth lactate, triphenyl bismuth, bismuth gallate, bismuth benzoate, bismuth citrate, bismuth methoxyacetate, bismuth acetate, bismuth formate, bismuth 2,2-dimethylolpropionate, etc. These can be used singly or as a mixture of two or more. Among these, it is preferable to use at least one bismuth compound selected from bismuth nitrate, bismuth lactate, bismuth trioxide, and bismuth methoxyacetate; and it is more preferable to use at least one bismuth compound selected from bismuth nitrate, bismuth lactate, and bismuth methoxyacetate.

The aqueous bismuth compound solution (A) contains a bismuth compound as described above, and preferably at least one bismuth compound selected from bismuth nitrate, bismuth lactate, and bismuth methoxyacetate, in an amount of preferably 30 to 30,000 ppm, more preferably 50 to 20,000 ppm, and even more preferably 100 to 5,000 ppm, on a metal mass basis. Use of the bismuth compound within the above ranges is preferable since it achieves excellent corrosion resistance, and in particular excellent weathering corrosion resistance, of the resulting film.

Examples of the acid to be used if necessary include water-soluble organic acids such as formic acid, acetic acid, lactic acid, methoxyacetic acid, etc., which can be used singly or as a mixture of two or more. Among these, formic acid, acetic acid, and methoxyacetic acid are preferable.

The amount of such an acid to be used is preferably 1 to 1000 mol, and more preferably 20 to 800 mol, per mol of the bismuth compound. Addition of the acid within the above ranges is preferable since it makes the deposition of the bismuth compound on the substrate easy and efficient.

The aqueous bismuth compound solution (A) may contain, if necessary, a water-dispersible or water-soluble resin composition.

Examples of the water-dispersible or water-soluble resin composition include cationic resin compositions containing, in the molecule, groups that can be converted into cations in an aqueous medium, such as amino groups, ammonium salt groups, sulfonium salt groups, phosphonium salt groups, etc.; and anionic resin compositions containing, in the molecule, groups that can be converted into anions in an aqueous medium, such as carboxyl groups, sulfonic acid groups, phosphoric acid groups, etc. Examples of the types of the resin include epoxy resins, acrylic resins, polybutadiene resins, alkyd resins, polyester resins, etc.

It is usually preferable that the amount of resin composition to be added if necessary be 40 mass % or less, more preferably 1 to 40 mass %, and even more preferably 0.5 to 20 mass %, relative to the mass of the aqueous bismuth compound solution (A).

The pH of the aqueous bismuth compound solution (A) is preferably within the range of 3.0 to 7.0, and more preferably 4.0 to 6.5. A pH within the above ranges is preferable since it inhibits corrosion of the equipment used for forming the film.

It is possible to use two or more kinds of aqueous bismuth compound solution (A) as a mixture.

### Coating Composition (B)

Examples of the coating composition (B) used in the present invention are not limited, and organic solvent-based coating compositions, aqueous coating compositions, powder coating compositions, etc., are usable.

The coating composition (B) may contain a resin, a curing agent, a curing catalyst, a surfactant, a surface preparation agent, and other additives.

Resins usable in the coating composition (B) include epoxy resins, acrylic resins, polyester resins, alkyd resins, silicone resins, fluororesins, etc.

Examples of crosslinking agents usable in the coating composition (B) include cold-setting or thermosetting crosslinking agents containing polyisocyanate compounds or amino resins, and crosslinking agents that are curable by irradiation with ultraviolet rays or electron beams.

Of these examples of the coating composition (B), heretofore known cationic electrodeposition coating compositions containing amine-added epoxy resins are preferable, since they have good corrosion resistance, and in particular good weathering corrosion resistance, as intended by the present invention.

Examples of the amine-added epoxy resins include polyamine resins that are conventionally used in electrodeposition coating compositions, such as:

(i) adducts of polyepoxide compounds and primary mono- and polyamines, secondary mono- and polyamines, or primary-secondary mixed polyamines (see, for example, U.S. Pat. No. 3,984,299, specification);
(ii) adducts of polyepoxide compounds with secondary mono- and polyamines having primary amino groups converted to ketimines (see, for example, U.S. Pat. No. 4,017,438, specification);
(iii) reaction products obtained by etherification of polyepoxide compounds with hydroxy compounds having primary amino groups converted to ketimines (see, for example, Japanese Unexamined Patent Publication No. 1984-43013); etc.

The amine value of the amine-added epoxy resin is not limited, but is preferably 30 to 70 mg KOH/g, and more preferably 40 to 70 mg KOH/g. The number average molecular weight of the amine-added epoxy resin is preferably 1,000 to 10,000, and more preferably 2,000 to 5,000.

The cationic electrodeposition coating composition may contain a curing agent, a curing catalyst, and/or various other additives, in addition to the amine-added epoxy resin.

Blocked polyisocyanate compounds for use as crosslinking agents in the cationic electrodeposition coating composition include aromatic, aliphatic, and alicyclic polyisocyanate compounds.

Examples of aromatic polyisocyanate compounds include 1,3- or 1,4-phenylene diisocyanate, 2,4- or 2,6-tolylene diisocyanate (TDI), crude TDI, 2,4′- or 4,4′-diphenylmethane diisocyanate (MDI), 4,4-diisocyanatobiphenyl, 3,3′-dimethyl-4,4′-diisocyanatobiphenyl, 3,3′-dimethyl-4,4′,4″-diisocyanatodiphenylmethane, crude MDI [polymethylene polyphenyl isocyanate], 1,5-naphthylene diisocyanate, 4,4′,4″-triphenylmethane triisocyanate, m- or p-isocyanatophenyl sulfonyl isocyanate, etc.

Examples of aliphatic polyisocyanate compounds include ethylene diisocyanate, tetramethylene diisocyanate, hexamethylene diisocyanate (HDI), p-xylylene diisocyanate (XDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate, 2-isocyanatoethyl-2,6-diisocyanatohexanoate, etc.

Examples of alicyclic polyisocyanate compounds include isophorone diisocyanate (IPDI), dicyclohexylmethane-4,4′-diisocyanate (hydrogenated MDI), α,α,α′,α′-tetramethylxylylene diisocyanate (TMXDI), cyclohexylene diisocyanate, etc.

Such polyisocyanate compounds can be blocked by adding a blocking agent to isocyanate groups of the polyisocyanate compounds. Examples of usable blocking agents include lactam-based compounds such as s-caprolactam and the like; oxime-based compounds such as methyl ethyl ketoxime, cyclohexanone oxime, etc.; aromatic alkyl alcohols such as phenyl carbinol, methyl phenyl carbinol, etc.; ether alcohol-based compounds such as ethylene glycol monobutyl ether and the like; etc.

The amount of crosslinking agent to be added is not limited and can be suitably selected depending on the formulation of the coating composition, but is preferably 10 to 70 parts by mass, and more preferably 25 to 50 parts by mass, per 100 parts by mass of the amine-added epoxy resin.

The amine-added epoxy resin is usually neutralized and dispersed in water after adding a crosslinking agent such as a blocked polyisocyanate compound, a surfactant, a surface preparation agent, a curing catalyst, and other additives, using an aliphatic carboxylic acid, such as acetic acid, formic acid, lactic acid, or like water-soluble organic acid, or the like, to thereby obtain an emulsion.

A cationic electrodeposition coating composition can be obtained by adding a pigment dispersion paste to the emulsion, adding additives and neutralizers as required, and diluting with deionized water or the like to a bath solids concentration of usually 5 to 40 mass %, and preferably 10 to 25 mass %, and a pH of usually 1.0 to 9.0, and preferably 3.0 to 7.0.

The pigment dispersion paste can be obtained, for example, by dispersing a pigment together with an organotin compound as a curing catalyst, a dispersing resin, and deionized water, in a ball mill, sand mill, or the like. The pigment dispersion paste may contain a neutralizer, if necessary.

Examples of usable pigments include organic or inorganic coloring pigments; extender pigments such as kaolin, baryta powder, precipitated barium sulfate, barium carbonate, calcium carbonate, calcium sulfate, clay, silica, white carbon, diatomaceous earth, talc, magnesium carbonate, alumina white, gloss white, mica powder, etc; and rust-preventing pigments such as aluminum tripolyphosphate, zinc tripolyphosphate, zinc white, inorganic bismuth, organic bismuth, etc. Examples of organotin compounds include dibutyltin oxide (DBTO), dioctyltin oxide (DOTO), etc. Examples of dispersing resins include tertiary amine-type epoxy resins, quaternary ammonium salt-type epoxy resins, tertiary amine-type acrylic resins, etc.

In the process of the present invention, since the coating film (F1) formed by immersion in the aqueous bismuth compound solution (A) can suppress corrosion of the metal substrate under the coating film, corrosion resistance can be obtained even it the coating composition (B) contains no amount of or a reduced amount of rust-preventing pigment or curing catalyst. This contributes to a reduction in the cost of coated articles.

Therefore, when a rust-preventing pigment is added, its content is preferably 30 parts by mass or less, and for example, 0.1 to 30 parts by mass, and preferably 1 to 10 parts by mass, per 100 parts by mass of the amine-added epoxy resin. The curing catalyst content is preferably 20 parts by mass or less, and for example, 0.01 to 20 parts by mass, and preferably 0.1 to 10 parts by mass, per 100 parts by mass of the amine-added epoxy resin.

### Process for Forming Multilayer Film

Formation of Coating film (F1)

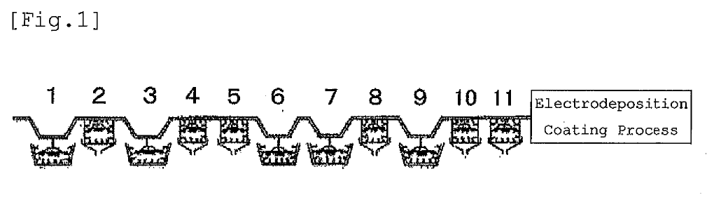

The coating film (F1) can be formed by applying an electric current of 1 to 200 V for 10 to 360 seconds, and preferably 2 to 100 V for 30 to 180 seconds, to the metal substrate, using a treatment vessel filled with the aqueous bismuth compound solution (A) as a bath, and the metal substrate as the cathode. Application of an electric current under the above conditions is preferable since it enables formation of a uniform, dense film. The thus obtained metal substrate having the coating film (F1) formed thereon, after or without washing with water, is suitably subjected to setting or thermal drying. Subsequently, the coating composition (B) is applied to form a coating film (F2) on the coating film (F1). FIG. 1 shows a model diagram of the steps of the process of the present invention.

The above-mentioned setting or thermal drying is performed under the conditions of preferably 0 to 80° C., more preferably 5 to 50° C., and even more preferably 10 to 40° C.; for preferably 10 seconds to 30 minutes, more preferably 20 seconds to 20 minutes, and even more preferably 30 seconds to 15 minutes; so that excess aqueous bismuth compound solution (A) adhering to the substrate can be removed. Further, during setting or thermal drying, the substrate may be subjected to air blowing, shaking, or the like.

The amount of bismuth adhered to the surface-treated substrate is preferably 10 to 1,000 mg/m², and more preferably 50 to 500 mg/m², on a metal basis. An amount of bismuth within the above range is preferable since it achieves excellent corrosion resistance, and in particular excellent weathering corrosion resistance, of the resulting film.

The thickness of the coating film (F1) is preferably 0.01 to 20 μm, and more preferably 0.1 to 10 μm, on a dry basis.

### Process for Forming Coating Film (F2)

The process for forming a multilayer film according to the present invention comprises forming a coating film (F2) by applying a coating composition (B) on the coating film (F) formed by immersing the metal substrate in the aqueous bismuth compound solution (A). In the present invention, excellent long-term corrosion resistance, such as weathering corrosion resistance and the like, is achieved by forming the coating film (F2) on the coating film (F1).

The coating composition (B) can be applied by, for example, a known method such as dip coating, shower coating, spray coating, roll coating, electrodeposition coating, or the like.

A preferred embodiment of the present invention is described below, in which cationic electrodeposition coating is carried out using a cationic electrodeposition coating composition as the coating composition (B).

The metal substrate having the coating film (F1) is immersed in an electrodeposition bath filled with a cationic electrodeposition coating composition, and an electric current of preferably 50 to 400 V, more preferably 100 to 370 V, and even more preferably 150 to 350 V, is applied for preferably 60 to 600 seconds, more preferably 120 to 480 seconds, and even more preferably 150 to 360 seconds, to thereby form the coating film (F2) on the coating film (F1). Application of an electric current under the above conditions is preferable from the viewpoint of the finishing properties and throwing power.

Application of an electric current in a bath filled with a cationic electrodeposition coating composition can be performed with an inter-electrode distance of usually 0.1 to 5 m, preferably 0.1 to 3 m, even more preferably 0.15 to 1 m, and an anode/cathode ratio of 1/8 to 2/1, and preferably 1/5 to 1/2.

The bath temperature of the cationic electrodeposition coating composition is usually 5 to 45° C., preferably 10 to 40° C., and more preferably 20 to 35° C.

After electrodeposition coating, to remove excess adhered cationic electrodeposition coating composition, the substrate is fully washed with ultrafiltrate (UF), RO permeate, industrial water, pure water, or the like, so that no cationic electrodeposition coating composition remains on the surface of the coated substrate.

The baking temperature for the coating film (F2) is 100 to 200° C., and preferably 120 to 180° C., at the surface of the substrate; and the baking time is 5 to 90 minutes, and preferably about 10 to about 50 minutes.

The thickness of the coating film (F2) is preferably 0.1 to 50 μm, and more preferably 1 to 30 μm, on a dry basis.

Metal Substrate with Multilayer Film

The thus obtained metal substrate with a multilayer film according to the present invention has excellent corrosion resistance, and in particular excellent weathering corrosion resistance, because of the coating film (F1) and coating film (F2). A coated article comprising such a metal substrate has excellent corrosion resistance, and in particular excellent weathering corrosion resistance. Specific examples of the coated article include building materials, electrical products, office machines, automotive bodies, parts, etc.

### BEST MODE FOR CARRYING OUT THE INVENTION

The following Production Examples, Examples, and Comparative Examples illustrate the present invention in further detail, but are not intended to limit the scope of the invention. In these examples, parts and percentages are by weight.

### Production of Aqueous Bismuth Compound Solution (A)

### PRODUCTION EXAMPLE 1

### Production of Aqueous Bismuth Compound Solution No. 1

To 3 parts of bismuth nitrate, 2,997 parts of 10% acetic acid was added and thoroughly stirred to obtain Aqueous Bismuth Compound Solution No. 1 with a solids content of 0.1%. The bath of Aqueous Bismuth Compound Solution No. 1 had a pH of 3.0.

### PRODUCTION EXAMPLE 2

### Production of Aqueous Bismuth Compound Solution No. 2

To 3 parts of bismuth lactate, 2,997 parts of 10% acetic acid was added and thoroughly stirred to obtain Aqueous Bismuth Compound Solution No. 2 with a solids content of 0.1%. The bath of Aqueous Bismuth Compound Solution No. 2 had a pH of 3.1.

### PRODUCTION EXAMPLE 3

### Production of Aqueous Bismuth Compound Solution No. 3

To 30 parts (3 parts as solids) of a 10% aqueous bismuth methoxyacetate solution, 2,970 parts of deionized water was added and thoroughly stirred to obtain Aqueous Bismuth Compound Solution No. 3 with a solids content of 0.1%. The bath of Aqueous Bismuth Compound Solution No. 3 had a pH of 4.0.

### Production of Chemical Conversion Liquid

### PRODUCTION EXAMPLE 4

### Production of Chemical Conversion Liquid A

### Zinc Phosphate-Based Chemical Conversion Liquid

Chemical Conversion Liquid A with the following formulation was prepared and used in the tests. The bath of Chemical Conversion Liquid A had a pH of 3.8.

### Formulation of Chemical Conversion Liquid A

| | |
|---|---|
| Zn²⁺ | 1.5 g/l |
| Ni²⁺ | 0.5 g/l |
| PO₄³⁻ | 13.5 g/l |
| F⁻ | 0.5 g/l |
| NO³⁻ | 6.0 g/l |
| NO²⁻ | 0.1 g/l |
| Na⁺ | 1.5 g/l |

### Production of Cationic Electrodeposition Coating Composition

### PRODUCTION EXAMPLE 5

### Production of Base Resin Solution No. 1

A 1,010 part quantity of jER828EL (tradename, an epoxy resin manufactured by Japan Epoxy Resins Co., Ltd.), 390 parts of bisphenol A, and 0.2 parts of dimethylbenzylamine were added to a separable flask with an inner volume of 2 l equipped with a thermometer, a reflux condenser, and a stirrer, and reacted at 130° C. until the epoxy equivalent reached 800.

Subsequently, 160 parts of diethanolamine and 65 parts of a ketimine-blocked diethylenetriamine were added; a reaction was carried out at 120° C. for 4 hours; and then 355 parts of ethylene glycol monobutyl ether was added to obtain Base Resin Solution No. 1 with a resin solids content of 80 mass %. The resin solids of Base Resin Solution No. 1 had an amine value of 67 and a number average molecular weight of 2,000.

### PRODUCTION EXAMPLE 6

### Production of Curing Agent No. 1

A 270 part quantity of Cosmonate M-200 (tradename, crude MDI manufactured by Mitsui Chemicals, Inc.) and 130 parts of methyl isobutyl ketone were added to a reaction vessel, and heated to 70° C. A 240 part quantity of ethylene glycol monobutyl ether was added dropwise thereto over a period of 1 hour. Thereafter, the mixture was heated to 100° C., and while maintaining the temperature, the mixture was sampled over time until no absorption by unreacted isocyanate groups was observed by infrared absorption spectrometry, to obtain Curing Agent No. 1 with a solids content of 80%.

### PRODUCTION EXAMPLE 7

### Production of Emulsion No. 1

An 87.5 part quantity (70 parts as solids) of Base Resin Solution No. 1 obtained in Production Example 5 was mixed with 37.5 parts (30 parts as solids) of Curing Agent No. 1 obtained in Production Example 6; 11 parts of 10% formic acid was added; and the resulting mixture was stirred to homogeneity. Thereafter, 158 parts of deionized water was added dropwise over about 15 minutes with strong stirring to obtain Emulsion No. 1.

### PRODUCTION EXAMPLE 8

### Production of Pigment-Dispersing Resin

A 390 part quantity of bisphenol A, 240 parts of Placcel 212 (tradename, polycaprolactone diol manufactured by Daicel Chemical Industries, Ltd., weight average molecular weight: about 1,250), and 0.2 parts of dimethylbenzylamine were added to 1,010 parts of jER828EL (tradename, an epoxy resin manufactured by Japan Epoxy Resin Co., Ltd.), and a reaction was carried out at 130° C. until the epoxy equivalent reached about 1,090.

Subsequently, 134 parts of dimethylethanolamine and 150 parts of an aqueous lactic acid solution with a concentration of 90% were added, a reaction was carried out at 120° C. for 4 hours, and then methyl isobutyl ketone was added to adjust the solids content, to obtain an ammonium-salt-type pigment-dispersing resin with a solids content of 60%. The ammonium-salt-type pigment-dispersing resin had an ammonium salt concentration of 0.78 mmol/g.

### PRODUCTION EXAMPLE 9

### Production of Pigment Dispersion Paste No. 1

An 8.3 part quantity (5 parts as solids) of the pigment-dispersing resin with a solids content of 60% obtained in Production Example 8, 14.5 parts of titanium oxide, 7.0 parts of purified clay, 0.3 parts of carbon black, 1 part of dioctyl tin oxide, 1 part of bismuth hydroxide, and 20.3 parts of deionized water were added to a ball mill, and dispersed for 20 hours to obtain Pigment Dispersion Paste No. 1 with a solids content of 55%.

### PRODUCTION EXAMPLE 10

### Production of Pigment Dispersion Paste No. 2 not Containing a Curing Catalyst

### Organic Tin Compound

An 8.3 part quantity (5 parts as solids) of the pigment-dispersing resin with a solids content of 60% obtained in Production Example 8, 14.5 parts of titanium oxide, 7.0 parts of purified clay, 0.3 parts of carbon black, 1 part of bismuth hydroxide, and 19.4 parts of deionized water were added to a ball mill, and dispersed for 20 hours to obtain Pigment Dispersion Paste No. 2 with a solids content of 55%.

### PRODUCTION EXAMPLE 11

### Production of Cationic Electrodeposition Coating Composition No. 1

A 294 part quantity (100 parts as solids) of Emulsion No. 1 obtained in Production Example 7, 52.4 parts (28.8 parts as solids) of Pigment Dispersion Paste No. 1 with a solids content of 55% obtained in Production Example 9, and 297.6 parts of deionized water were mixed together to produce Cationic Electrodeposition Coating Composition No. 1 with a solids content of 20%.

### PRODUCTION EXAMPLE 12

### Production of Cationic Electrodeposition Coating Composition No. 2

A 294 part quantity (100 parts as solids) of Emulsion No. 1 obtained in Production Example 7, 50.5 parts (27.8 parts as solids) of Pigment Dispersion Paste No. 2 with a solids content of 55% obtained in Production Example 10, and 294.5 parts of deionized water were mixed together to produce Cationic Electrodeposition Coating Composition No. 2 with a solids content of 20%.

Cold Rolled Steel Sheet/Chemical Conversion/Treatment with Aqueous Bismuth Compound Solution (A)

### EXAMPLE 1

Test Plate No. 1 was obtained by the following Steps 1 to 5.

Step 1: A cold rolled steel sheet (70 mm×150 mm×0.8 mm) was treated by immersion for 120 seconds in 2 mass % “Fine Cleaner L4460” (an alkaline degreasing agent manufactured by Nihon Parkerizing Co.) adjusted to 43° C.; subjected to surface preparation by immersion at 25° C. for 30 seconds in a 0.15% aqueous solution of Preparen 4040N (a surface preparation agent manufactured by Nihon Parkerizing Co., Ltd.); and washed by being sprayed with tap water for 30 seconds. The surface-prepared steel sheet was treated by immersion for 120 seconds in a bath containing Chemical Conversion Liquid A of Production Example 4 adjusted to 43° C., and washed by being sprayed with water.

Step 2: The test plate obtained in Step 1 was immersed in Aqueous Bismuth Compound Solution No. 1 adjusted to 28° C., and an electric current of 5 V was applied for 180 seconds using the test plate as the cathode. The inter-electrode distance was 0.15 m and the anode/cathode ratio was 1/2.

Step 3: The test plate obtained in Step 2 was withdrawn and washed by being sprayed with tap water at 15° C. for 30 minutes.

Step 4: The test plate obtained in Step 3 was dried at 35° C. for 10 minutes. The amount of bismuth on the surface-treated plate was measured using an X-ray fluorescence spectrometer (tradename “RIX-3100”, manufactured by Rigaku Corporation). As a result, the amount of Aqueous Bismuth Compound Solution No. 1 adhered was 108 mg/m² on a metal basis.

Step 5: Cationic Electrodeposition Coating Composition No. 1 obtained in Production Example 11 was applied by electrodeposition at 250 V for 3 minutes, and baked at 170° C. for 20 minutes to obtain an electrodeposition coating film with a dry thickness of 20 μm.

### EXAMPLES 2 TO 4

Test plates No. 2 to No. 4 were obtained in the same manner as Example 1 except for using the aqueous bismuth compound solutions and application conditions shown in Table 1.

TABLE 1

| | | | Ex. 1 | Ex. 2 | Ex. 3 | Ex. 4 |
|---|---|---|---|---|---|---|
| Test Plate | | | No. 1 | No. 2 | No. 3 | No. 4 |
| Metal Substrate | | | Cold | Cold | Cold | Cold |
| | | | Rolled | Rolled | Rolled | Rolled |
| | | | Steel | Steel | Steel | Steel |
| | | | Sheet | Sheet | Sheet | Sheet |
| Step 1 | Degreasing | Fine Cleaner | 43 | 43 | 43 | 43 |
| Pre-Treatment | | L4460 (° C.) | | | | |
| | | Treatment | 120 | 120 | 120 | 120 |
| | | Time (sec) | | | | |
| | Surface | Preparen | 25 | 25 | 25 | 25 |
| | Preparation | 4040N (° C.) | | | | |
| | | Treatment Time | 30 | 30 | 30 | 30 |
| | | (sec) | | | | |
| | Chemical | Chemical | 43 | 43 | 43 | 43 |
| | Conversion | Conversion | | | | |
| | | Liquid A | | | | |
| | | (° C.) | | | | |
| | | Treatment | 120 | 120 | 120 | 120 |
| | | Time (sec) | | | | |

| | | | | | |
|---|---|---|---|---|---|
| Step 2 | Aqueous Bismuth Compound | No. 1 | No. 2 | No. 3 | No. 1 |
| Post- | Solution | | | | |
| Treatment | Voltage (V) | 5 | 5 | 5 | 15 |
| | Time (sec) | 180 | 180 | 180 | 180 |
| Step 3 | Washing Water (° C.) | 15 | 15 | 15 | 15 |
| Water | Washing Time (sec) | 30 | 30 | 30 | 30 |
| Washing | | | | | |
| Step 4 | Temperature (° C.) | 35 | 35 | 35 | 35 |
| Drying | Time (min) | 10 | 10 | 10 | 10 |
| | Amount Adhered (mg/m²) | 108 | 100 | 90 | 137 |
| Step 5 | Cationic | No. 1 | No. 1 | No. 1 | No. 2 |
| | Electrodeposition Coating | | | | |
| | Composition | | | | |

| | | | | |
|---|---|---|---|---|
| Corrosion Resistance | a | a | a | a |
| Weathering Resistance | a | a | a | a |

Cold Rolled Steel Sheet/Without Chemical Conversion/Treatment with Aqueous Bismuth Compound Solution (A)

### EXAMPLE 5

Test Plate No. 5 was obtained by the following Steps 1 to 5.

Step 1: A cold rolled steel sheet (70 mm×150 mm×0.8 mm) was treated by immersion for 120 seconds in 2 mass % “Fine Cleaner L4460” (an alkaline degreasing agent manufactured by Nihon Parkerizing Co.) adjusted to 43° C.;

Step 2: The test plate obtained in Step 1 was immersed in Aqueous Bismuth Compound Solution No. 1 adjusted to 28° C. and an electric current of 5 V was applied for 180 seconds using the test plate as the cathode. The inter-electrode distance was 0.15 m and the anode/cathode ratio was 1/2.

Step 3: The test plate obtained in Step 2 was withdrawn and washed by being sprayed with tap water at 15° C. for 30 minutes.

Step 4: The test plate obtained in Step 3 was dried at 35° C. for 10 minutes. The amount of bismuth on the surface-treated plate was measured using an X-ray fluorescence spectrometer (tradename “RIX-3100”, manufactured by Rigaku Corporation). As a result, the amount of Aqueous Bismuth Compound Solution No. 1 adhered was 128 mg/m on a metal basis.

Step 5: Cationic Electrodeposition Coating Composition No. 1 obtained in Production Example 11 was applied by electrodeposition at 250 V for 3 minutes and baked at 170° C. for 20 minutes to obtain an electrodeposition coating film with a dry thickness of 20 μm.

### EXAMPLES 6 TO 8

Test plates No. 6 to No. 8 were obtained in the same manner as Example 5 except for using the aqueous bismuth compound solutions and application conditions shown in Table 2.

TABLE 2

| | | | Ex. 5 | Ex. 6 | Ex. 7 | Ex. 8 |
|---|---|---|---|---|---|---|
| Test Plate | | | No. 5 | No. 6 | No. 7 | No. 8 |
| Step 1 | Substrate | | Cold | Cold | Cold | Cold |
| Pre-Treatment | | | Rolled | Rolled | Rolled | Rolled |
| | | | Steel | Steel | Steel | Steel |
| | | | Sheet | Sheet | Sheet | Sheet |
| | Degreasing | Fine Cleaner | 43 | 43 | 43 | 43 |
| | | L4460 (° C.) | | | | |
| | | Treatment Time | 120 | 120 | 120 | 120 |
| | | (sec) | | | | |
| | Surface | Preparen | — | — | — | — |
| | Preparation | 4040N (° C.) | | | | |
| | | Treatment | — | — | — | — |
| | | Time (sec) | | | | |
| | Chemical | Chemical | — | — | — | — |
| | Conversion | Conversion | | | | |
| | | Liquid A | | | | |
| | | (° C.) | | | | |
| | | Treatment | — | — | — | — |
| | | Time (sec) | | | | |

| | | | | | |
|---|---|---|---|---|---|
| Step 2 | Aqueous Bismuth Compound | No. 1 | No. 2 | No. 3 | No. 1 |
| Post- | Solution | | | | |
| Treatment | Voltage (V) | 5 | 5 | 5 | 15 |
| | Time (sec) | 180 | 180 | 180 | 180 |
| Step 3 | Washing Water (° C.) | 15 | 15 | 15 | 15 |
| Water | Water Washing Time (sec) | 30 | 30 | 30 | 30 |
| Washing | | | | | |
| Step 4 | Temperature (° C.) | 35 | 35 | 35 | 35 |
| Drying | Time (min) | 10 | 10 | 10 | 10 |
| | Amount Adhered (mg/m²) | 128 | 115 | 100 | 158 |
| Step 5 | Cationic | No. 1 | No. 1 | No. 1 | No. 2 |
| | Electrodeposition Coating | | | | |
| | Composition | | | | |

| | | | | |
|---|---|---|---|---|
| Corrosion Resistance | b | b | b | b |
| Weathering Resistance | b | b | b | b |

### COMPARATIVE EXAMPLE 1

Test Plate No. 9 was obtained by the following Steps 1, 3 to 5.

Step 1: A cold rolled steel sheet (70 mm×150 mm×0.8 mm) was treated by immersion for 120 seconds in 2 mass % “Fine Cleaner L4460” (an alkaline degreasing agent manufactured by Nihon Parkerizing Co.) adjusted to 43° C.; subjected to surface preparation by immersion at 25° C. for 30 seconds in a 0.15% aqueous solution of Preparen 4040N (a surface preparation agent manufactured by Nihon Parkerizing Co., Ltd.); and washed by being sprayed with tap water for 30 seconds. The surface-prepared steel sheet was treated by immersion for 120 seconds in a bath containing Chemical Conversion Liquid A of Production Example 4 adjusted to 43° C.

Step 3: The test plate obtained in Step 1 was withdrawn and washed by being sprayed with tap water at 15° C. for 30 minutes.

Step 4: The test plate obtained in Step 3 was dried at 35° C. for 10 minutes.

Step 5: Cationic Electrodeposition Coating Composition No. 1 obtained in Production Example 11 was applied by electrodeposition at 250 V for 3 minutes, and baked at 170° C. for 20 minutes to obtain an electrodeposition coating film with a dry thickness of 20 μm.

### COMPARATIVE EXAMPLE 2

Test Plate No. 10 was obtained by the following Steps 1, 3 to 5.

Step 1: A cold rolled steel sheet (70 mm×150 mm×0.8 mm) was treated by immersion for 120 seconds in 2 mass % “Fine Cleaner L4460” (an alkaline degreasing agent manufactured by Nihon Parkerizing Co.) adjusted to 43° C., to obtain a degreased plate.

Step 3: The test plate obtained in Step 1 was withdrawn and washed by being sprayed with tap water at 15° C. for 30 minutes.

Step 4: The test plate obtained in Step 3 was dried at 35° C. for 10 minutes.

Step 5: Cationic Electrodeposition Coating Composition No. 1 obtained in Production Example 11 was applied to the degreased plate by electrodeposition at 250 V for 3 minutes, and baked at 170° C. for 20 minutes to obtain an electrodeposition coating film with a dry thickness of 20 μm.

### COMPARATIVE EXAMPLE 3

Test Plate No. 11 was obtained by the following Steps 1, 3 to 5.

Step 1: A cold rolled steel sheet (70 mm×150 mm×0.8 mm) was treated by immersion for 120 seconds in 2 mass % “Fine Cleaner L4460” (an alkaline degreasing agent manufactured by Nihon Parkerizing Co.) adjusted to 43° C. The test plate obtained in Step 1 was treated by immersion for 120 seconds in a bath containing Chemical Conversion Liquid A of Production Example 4 adjusted to 43° C.

Step 3: The test plate obtained in Step 1 was withdrawn and washed by being sprayed with tap water at 15° C. for 30 minutes.

Step 4: The test plate obtained in Step 3 was dried at 35° C. for 10 minutes.

Step 5: Cationic Electrodeposition Coating Composition No. 2 obtained in Production Example 12 was applied by electrodeposition at 250 V for 3 minutes, and baked at 170° C. for 20 minutes to obtain an electrodeposition coating film with a dry thickness of 20 μm.

### COMPARATIVE EXAMPLE 4

Test Plate No. 12 was obtained by the following Steps 1 to 4.

Step 1: A cold rolled steel sheet (70 mm×150 mm×0.8 mm) was treated by immersion for 120 seconds in 2 mass % “Fine Cleaner L4460” (an alkaline degreasing agent manufactured by Nihon Parkerizing Co.) adjusted to 43° C.;

Step 2: The test plate obtained in Step 1 was immersed in Aqueous Bismuth Compound Solution No. 1 adjusted to 28° C., and an electric current of 5 V was applied for 180 seconds using the test plate as the cathode. The inter-electrode distance was 0.15 m, and the anode/cathode ratio was 1/2.

Step 3: The test plate obtained in Step 2 was withdrawn and washed by being sprayed with tap water at 15° C. for 30 minutes.

Step 4: The test plate obtained in Step 3 was dried at 35° C. for 10 minutes. The amount of bismuth on the surface-treated plate was measured using an X-ray fluorescence spectrometer (tradename “RIX-3100”, manufactured by Rigaku Corporation). As a result, the amount of Aqueous Bismuth Compound Solution No. 1 adhered was 128 mg/m² on a metal basis.

TABLE 3

| | | | Comp. | Comp. | Comp. | Comp. |
|---|---|---|---|---|---|---|
| | | | Ex. 1 | Ex. 2 | Ex. 3 | Ex. 4 |
| Test Plate | | | No. 9 | No. 10 | No. 11 | No. 12 |
| Step 1 | Substrate | | Cold | Cold | Cold | Cold |
| Pre-Treatment | | | Rolled | Rolled | Rolled | Rolled |
| | | | Steel | Steel | Steel | Steel |
| | | | Sheet | Sheet | Sheet | Sheet |
| | Degreasing | Fine Cleaner | 43 | 43 | 43 | 43 |
| | | L4460 (° C.) | | | | |
| | | Treatment Time | 120 | 120 | 120 | 120 |
| | | (sec) | | | | |
| | Surface | Preparen | 25 | — | — | — |
| | Preparation | 4040N (° C.) | | | | |
| | | Treatment | 30 | — | — | — |
| | | Time (sec) | | | | |
| | Chemical | Chemical | 43 | — | 43 | — |
| | Conversion | Conversion | | | | |
| | | Liquid A (° C.) | | | | |
| | | Treatment | 120 | — | 120 | — |
| | | Time (sec) | | | | |

| | | | | | |
|---|---|---|---|---|---|
| Step 2 | Aqueous Bismuth Compound | — | — | — | No. 1 |
| Post- | Solution | | | | |
| Treatment | Voltage (V) | — | — | — | 5 |
| | Time (sec) | — | — | — | 180 |
| Step 3 | Washing Water (° C.) | 15 | 15 | 15 | 15 |
| Water | Washing Time (sec) | 30 | 30 | 30 | 30 |
| Washing | | | | | |
| Step 4 | Temperature (° C.) | 35 | 35 | 35 | 35 |
| Drying | Time (min) | 10 | 10 | 10 | 10 |
| | Amount Adhered (mg/m²) | — | — | — | 128 |
| Step 5 | Cationic Electrodeposition | No. 1 | No. 1 | No. 2 | — |
| | Coating Composition | | | | |

| | | | | |
|---|---|---|---|---|
| Corrosion Resistance | c | e | d | e |
| Weathering Resistance | c | e | d | e |

### Test Methods

Test Plates No. 1 to No. 12 obtained above were tested using the following methods. Tables 1 to 3 show the results.

Corrosion Resistance: Crosscuts were formed in the electrodeposition coating film using a knife so that the cuts reached the substrate of each test plate, and the resulting test plate was subjected to a salt spray resistance test for 480 hours according to JIS Z-2371. The results were evaluated according to the following criteria by measuring the width of rusting or blistering from the cuts.
a: The maximum width of rusting or blistering was less than 2 mm from the cuts (on one side).
b: The maximum width of rusting or blistering was not less than 2 mm and less than 2.5 mm from the cuts (on one side).
c: The maximum width of rusting or blistering was not less than 2.5 mm and less than 3.0 mm from the cuts (on one side).
d: The maximum width of rusting or blistering was not less than 3.0 mm and less than 3.5 mm from the cuts (on one side).
e: The maximum width of rusting or blistering was not less than 3.5 mm from the cuts (on one side).

Weathering Resistance: WP-300 (tradename, an aqueous intermediate coating composition manufactured by Kansai Paint Co., Ltd.) was applied to each test plate by spray coating to a cured thickness of 25 μm, and then baked using an electrical hot-air dryer at 140° C. for 30 minutes. Subsequently, Neo Amilac 6000 (tradename, a thermosetting top-coating composition manufactured by Kansai Paint Co., Ltd.) was applied over the intermediate coating film by spray coating to a cured thickness of 35 μm, and then baked using an electric hot-air dryer at 140° C. for 30 minutes, to obtain a weathering test plate. Crosscuts were formed in the coating film of the obtained weathering test plate using a knife so that the cuts reached the substrate of the test plate, and the resulting test plate was weathered for 1 year in a horizontal position in Chikura-cho, Chiba Prefecture, Japan. The results were evaluated according to the following criteria by measuring the width of rusting or blistering from the cuts.
a: The maximum width of rusting or blistering was less than 2 mm from the cuts (on one side).
b: The maximum width of rusting or blistering was not less than 2 mm and less than 2.5 mm from the cuts (on one side).
c: The maximum width of rusting or blistering was not less than 2.5 mm and less than 3.0 mm from the cuts (on one side).
d: The maximum width of rusting or blistering was not less than 3.0 mm and less than 3.5 mm from the cuts (on one side).
e: The maximum width of rusting or blistering was not less than 3.5 mm from the cuts (on one side).

The present invention provides a process for producing a metal substrate with a multilayer film that has excellent corrosion resistance, and, in particular, excellent weathering resistance; and the metal substrate and coated article obtained by the process have excellent corrosion resistance, and, in particular, excellent weathering corrosion resistance.

The excellent stability of the aqueous bismuth compound solution (A) enables the continuous production of coated articles on an industrial coating line. Further, it is possible for the coating composition (B) to contain no, or less than a normal amount of, rust preventive pigment or curing catalyst.

1. A process for forming a multilayer film, comprising immersing a metal substrate in an aqueous bismuth compound solution (A) and applying an electric current between the metal substrate and an electrode to thereby form a coating film (F1) on the metal substrate; and then applying a coating composition (B) on the coating film (F1) to form a coating film (F2).

2. A metal substrate with a multilayer film, which is obtained by the process according to claim 1.

3. A process for producing a metal substrate with a multilayer film, comprising immersing a metal substrate in an aqueous bismuth compound solution (A) and applying an electric current between the metal substrate and an electrode to thereby form a coating film (F1) on the metal substrate; and then applying a coating composition (B) on the coating film (F1) to form a coating film (F2).

4. The process according to claim 3, wherein the aqueous bismuth compound solution (A) is an aqueous solution containing at least one bismuth compound selected from the group consisting of bismuth nitrate, bismuth lactate, and bismuth methoxyacetate.

5. The process according to claim 3, wherein the metal substrate is a metal substrate treated by zinc phosphate-based chemical conversion.

6. A metal substrate with a multilayer film, which is obtained by the process according to claim 3.

7. A coated article comprising the metal substrate according to claim 6.

8. A coated article comprising the metal substrate according to claim 2.
